(19) United States
(12) Patent Application Publication
(10) Pub. No.: US 2009/0078133 A1
(43) Pub. Date: Mar. 26, 2009

(54) THIN-WALLED HOT FOIL STAMPING CYLINDER AND METHOD OF FABRICATION

(75) Inventors: Larry R. Hutchison, Overland Park, KS (US); Derek Smith, West Sussex (GB)

Correspondence Address: HOVEY WILLIAMS LLP, 10801 Mastin Blvd., Suite 1000, Overland Park, KS, 66210, US

(73) Assignee: Universal Engraving, Inc., Overland Park, KS (US)

(21) Appl. No.: 11/859,620

(22) Filed: Sep. 21, 2007

(51) Int. Cl. B41F 3/00; B21D 53/00

(52) U.S. Cl. 101/27; 29/895.3

(57) ABSTRACT

A thin-walled hot foil stamping cylinder of predetermined diameter is formed from an extruded cylindrical tube having a wall of initially uniform cross-sectional thickness. Portions of the outer cylindrical surface of the wall are relieved to define raised, outwardly-projecting hot foil stamping indicia. End caps close opposed ends of the cylindrical tube. One of the end caps is provided with a passage therethrough for introduction of hot oil into the cylindrical interior space of the tube. A passage in at least one of the end caps that communicates with the interior of the tube permits selective draining of oil from the tube. The overall outer surface of the tube may be machined to reduce the tube to a predetermined diameter, prior to relieving the surface thereof to form the indicia. In this manner, a single extruded tube may be used to produce hot foil stamping cylinders of individual diameters corresponding to standard image repeats.

### BACKGROUND OF THE INVENTION

1. Field of the Invention

This invention relates to the field of graphic arts, and especially to an oil-filled hot foil stamping cylinder. Hot foil stamping cylinders have long been used to transfer hot stamping foil carried on a suitable substrate to an art work image on web material. In lieu of a cylinder machined from a solid brass rod as previously used, this hot foil stamping cylinder includes a thin walled tube of uniform cross-sectional thickness having redesigned end caps presenting respectively, a shaft end, and an extension for connection to the gear side of a graphic arts press. The outer surface of the cylinder generally was machined to provide a surface of required OD depending upon the repeat pattern of the art work on the web to be foil stamped, i.e. 22″, 23″, 24″ or 25″ repeat lengths, and the design image then engraved on the working surface of the cylinder. Manifestly, each of the cylinders had only one use for a respective job.

2. Description of the Prior Art

It has been conventional for many years to transfer hot stamping foil to art work on a web of material using a rotary cylinder having raised design defining indicia on the outer surface of the cylinder. The cylinder had in internal cavity for receipt of hot oil. Upon start up, the hot oil was introduced into the interior of the cylinder and circulated at a predetermined flow rate in order to maintain the outer surface of cylinder at a required working temperature, e.g. within a proximate range of 300-375° F. During each revolution of the cylinder, when each design indicia contacted the substrate for transfer of foil, the temperature of the design surface of the cylinder was decreased. Accordingly, there was a finite limitation on the speed at which the cylinder could operate in order to maintain the surface temperature of the design indicia at a requisite level upon engagement with the art work substrate. In one revolution of the cylinder, if the design image next brought into registration with the art work on the substrate, had not recovered the heat that had been loss in the preceding foil transfer the machine speed had to be decreased until equilibrium was reached between heat loss and recovery of heat around the full circumference of the cylinder.

Hot foil stamping cylinders now in use have been machined from a cylindrical solid brass member. A cavity was formed in the brass cylinder having an enlarged central section and two unitary end segments of smaller internal diameter providing ends of sufficient size and thickness for receipt of a support shaft end and a gear shaft end respectively. Because the innermost internal cavity was, of necessity, of larger diameter than the end cavity segments, machining of the solid piece of brass was carried out using cantilever machining tools. As a result, the wall thickness of the cylinder defining the innermost internal cavity could be no more than a certain minimum dimension dictated by the distance of the center line of the tool from its outer working edge. The internal volume of the machined cylinder was therefore a function of the size of the larger innermost cavity and the smaller two end cavity segments.

A number of operating and economic disadvantages were inherit in the existing hot foil stamping cylinder designs. It was very expensive and time consuming to machine out the center portion of a solid rod of brass that nominally was of the order of 8 in. in diameter and as much as 14 in. in length, particularly where the remaining wall thickness of the main cavity in the cylinder following machining was only of the order of ¾ in. The resulting cylinder then had to be further machined to a required external diameter depending upon the repeat pattern of the art work to be hot foil stamped with the cylinder. The amount of hot oil that could be circulated through the internal cavities of the cylinder was limited by the volume of the cavities. As noted, rotation of the cylinder was dictated by the heat loss and heat recovery time of the outer surface of the cylinder. In addition, it was costly to ship the very heavy cylinders over extended distances from the manufacturer to the user.

### SUMMARY OF THE INVENTION

The thin-walled hot foil stamping cylinder of this invention comprises a cylindrical tube having a circumferentially-extending wall of predetermined diameter and of initially uniform cross-sectional thickness. The wall of the cylinder defines a central interior space extending the full length of the tube. End caps are provided across each of the opposed ends of the tube, with one of the end caps being provided with an oil fill passage therethrough for introduction of hot oil into the interior space of the tube. A hot oil delivery conduit extends through the passage in the one end cap into the interior cavity of the tube. Hot oil introduced into the cylinder and that circulates through the cavity is removed from the end cap externally of the delivery conduit. Portions of the outer cylindrical surface of the wall of the tube are relieved to define raised, outwardly-projecting hot foil stamping indicia.

Preferably, the hot foil stamping cylinder is fabricated from an extruded metal tube, e.g. brass that has an initial wall thickness of from about 0.35 in. to 0.95 in. and that is cut to a suitable length. It will be appreciated by those of ordinary skill in the art that the cylinder may be fabricated from other suitable materials, such as a cast metal tube. End caps are bolted to opposite ends of the cylinder, with the shaft of the end cap having an oil fill passage therethrough being adapted to be received in a suitable rotary coupling or union, while the other end cap has a shaft for mounting of a press drive gear. At least one of the end caps has a radially extending, selectively openable oil drain passage communicating with the interior of the tube, although it is to be preferred that both of the end caps be provided with such oil drain passages.

The oil fill passage in the shaft of one of the end caps is preferably of the order of ¾ in. in diameter. Thus, the in-flow of oil through the hot oil delivery conduit may be as much as about 10 litres per minute into a cylinder having an internal volume of about 7.53 litres equaling about 1.33 oil changeovers per minute. In the past, the oil fill passage has conventionally been ½ in. in diameter, permitting oil flow at 5 litres per minute into a 5.06 litre cylinder thereby equaling about 0.99 oil changeovers per minute. Therefore the present hot oil foil stamping cylinder provides for an increase in oil changeover of about 34% as compared with a conventional brass cylinder machined from a solid rod. The volume of oil contained in the thin-walled hot foil stamping cylinder of this invention is at least about 35-40% greater than in the same size traditional cylinder, and nominally is at least about 400 cubic inches.

A conventional brass cylinder (machined from a solid rod) having a central minimum wall thickness of the order of ¾ in. can be replaced with a hot foil cylinder of the present design in which the tube from which the cylinder is manufactured can be no more than about 0.6 in. in thickness, representing a 25% reduction. Likewise, a conventional brass cylinder having a minimum wall thickness of the order of 0.9 in. can be replaced with a tube having a wall thickness of the order of 0.7 in. representing a 20% reduction. Similarly, a conventional brass cylinder having a minimum wall thickness of the order of 1.063 in. may be replaced with a tube having a wall thickness of the order of 0.877 in., equaling a wall thickness reduction of 18%. With the inventive cylinder, the variations in wall thicknesses can correspond with different repeat lengths. In other words, with a given tube diameter, the wall thickness will vary depending upon the repeat length. It is also noted that the inventive cylinder is capable of being re-machined, from a larger repeat length to a smaller repeat length, permitting the cylinder to be reused.

The decrease in shipping charges of a conventional brass cylinder (machined from a solid rod) as compared with a tube based cylinder of the present invention is equally significant. For example, a conventional hollowed-out brass cylinder (in its assembled form) of the order of 14¼ in. in length typically weighed at least about 99 pounds. A similar length cylinder of this invention (in its assembled form) weighs no more than about 67 pounds, representing a weight reduction of as much as 32%.

### BRIEF DESCRIPTION OF THE DRAWINGS

FIG. 1 is a perspective view of a thin wall hot foil stamping cylinder in accordance with the present invention;

FIG. 2 is an end view of the cylinder of FIG. 1 showing the oil inlet end cap of the cylinder;

FIG. 3 is a cross-sectional view taken along the line 3-3 of FIG. 2 and looking in the direction of the arrows;

FIG. 4 is a fragmentary cross-sectional view illustrating the bolts for connecting the end caps to the cylindrical tube of the hot foil stamping cylinder; and

FIG. 5 is a perspective view of the inside of the end cap having an oil fill passage therethrough.

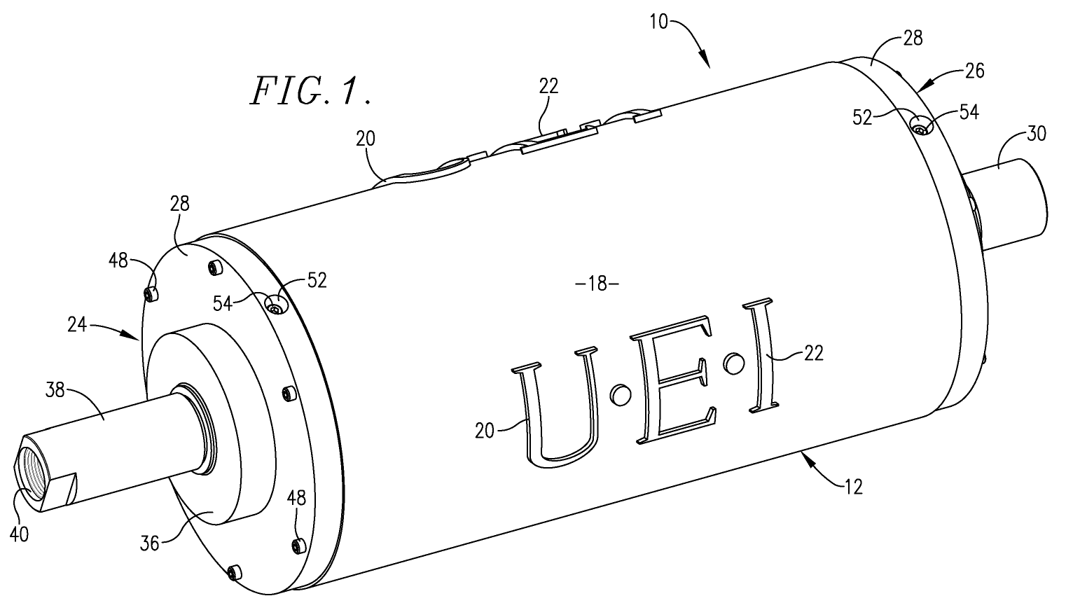

### DETAILED DESCRIPTION OF THE PREFERRED EMBODIMENT

The thin-walled hot foil stamping cylinder broadly designated 10 includes a cylindrical tube 12 of initial predetermined diameter and of substantially uniform cross-sectional thickness. Tube 12, preferably extruded from brass or a brass alloy (e.g., a 353 brass alloy), nominally is of a diameter of about 8 in., although other tube diameters (e.g., 7 in. or 9 in) may be suitable. The thickness of the wall 14 of the tube 12 is within the range of about 0.35 in. to about 0.95 in., and preferably is within the range of about 0.4 in. to about 0.88 in., with intermediate wall thicknesses being of the order of about 0.56 in. and 0.72 in. As is customary, the length of tube 12 is preferably dimensioned to fit into the space between the end caps of a specific press on which cylinder 10 is designed to be mounted. In narrow web presses, the length of the tube is nominally in the range of about 10 in. to about 30 in. Although the principles of the present invention are most preferably used in narrow web processes, it is also possible to construct the cylinder 10 for wider web applications, such as about 41 in.

For economy purposes, tubes 12, made to conform to controlled material composition and quality specifications, are fabricated of uniform external and internal diameters. The outer face 18 of tube 12 may then be machined to a degree that the diameter of the outer surface is correlated with specified 22″, 23″, 24″, or 25″ image repeat lengths of the images on the substrate to be hot foil stamped, in accordance with standard graphic arts practice. Then, the face 18 of tube 12 is engraved, as by machining (including laser machining), use of an etching solution, or the like, to form design-defining indicia 20 in which the surfaces 22 remain in the imaginary cylinder that conforms to the desired 22″, 23″, 24″, or 25″ image repeat length pattern.

End caps 24 and 26 are mounted on respective opposed ends of tube 12. Both end caps 24 and 26 are preferably of one-piece construction and include a circular flange 28. End cap 26 has a central section 30 provided with a shaft extension 32, and is adapted to receive a press drive gear connected to extension 32 by bolts threaded into respective bores 34 in central section 30.

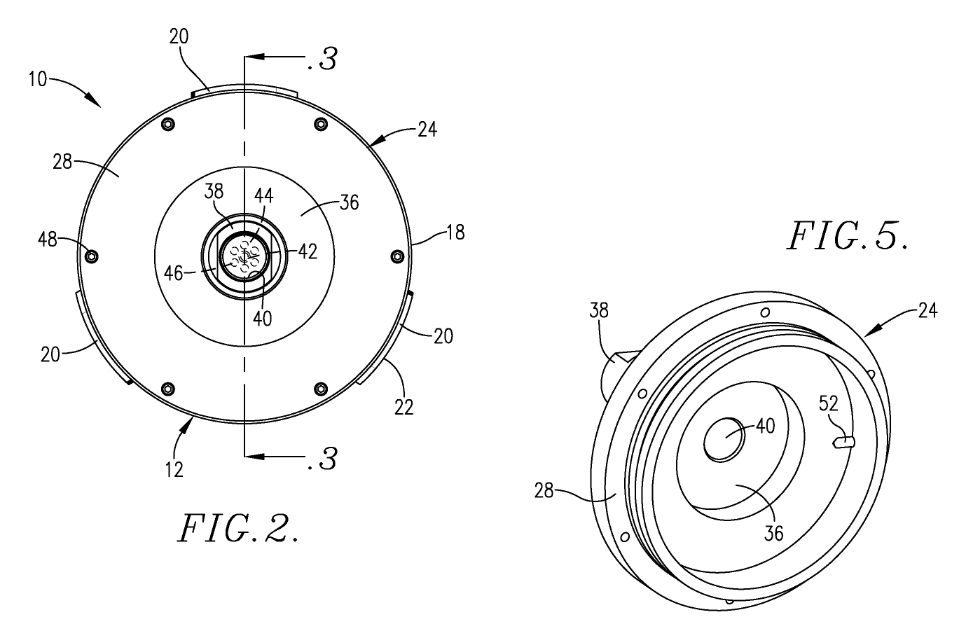

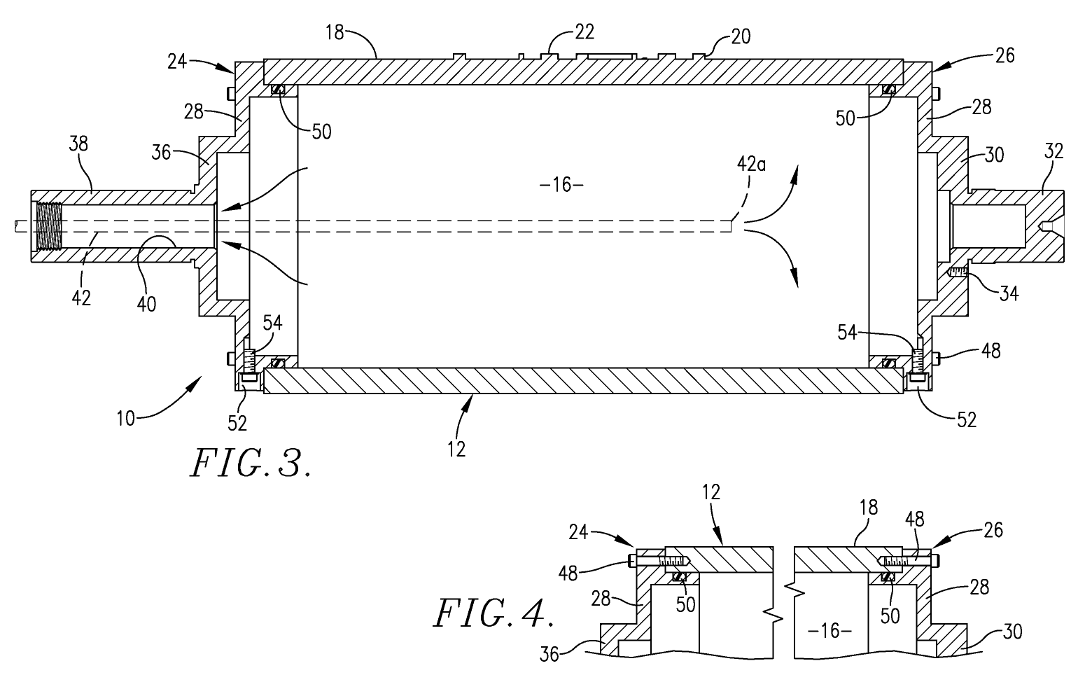

The central section 36 of end cap 24 that is unitary with flange 28, has an outwardly-projecting tubular shaft 38 provided with a central passage 40 communicating with the cavity 16 of tube 12. The passage 40 is preferably about ¾ in. in diameter, as compared with conventional ½ in. oil delivery passages A hot oil delivery conduit 42 extends through passage 40 about ⅔ of the way into the interior of tube 12. It is to be observed from FIG. 3, that the innermost end 42a of conduit 42 extends toward, but is spaced inwardly from, end cap 26. Hot oil directed through conduit 42 is introduced into cavity 16 for circulation throughout the extent thereof, and returns to the source of hot oil through passage 40 exteriorly of conduit 42. A cross-fitting 44 (FIG. 2), surrounding conduit 42, has a series of openings 46 allowing hot oil to return to the oil supply and heater unit.

Bolts 48 extending through the outer peripheral portions of flanges 28 of end caps 24 and 26 are threaded into opposite ends of tube 12 for affixing the end caps to the tube. An O-ring 50, disposed between the inwardly extending annular lip of each flange 28 and the interior surface of tube 12 seals the interior of cavity 16. The flanges 28 of end caps 24 and 26 have axial drain passages 52 that communicate with cavity 16 of tube 12. Bolts 54 are threaded into and normally close passages 52.

Exemplary cylinders of this invention, as depicted in the drawings hereof for 22″, 23″, 24″, and 25″ repeat length patterns, may be of the following dimensions:

EXAMPLE¹

| Repeat | | Internal | | Representative |
|---|---|---|---|---|
| Length | Pitch Diameter | Diameter | Wall Thickness | Cylinder Length |
| (inches) | (inches) | (inches) | (inches) | (inches) |
| 22 | 7.002817496 | 6.2031 | 0.399858748 | 14.0125 |
| 23 | 7.321127382 | 6.2031 | 0.559013691 | 14.0125 |
| 24 | 7.639437268 | 6.2031 | 0.718168634 | 14.0125 |
| 25 | 7.957747155 | 6.2031 | 0.877323577 | 14.0125 |

¹The pitch diameter is the diameter of the outer surface 22 of the design-defining indicia 20 of the cylinder 10.

The cylinder oil capacity of each of the representative cylinders in the above Example is 442.81 cubic inches. The cylinder oil capacity of a conventional hollowed-out hot foil stamping cylinder of the same length is only 308.62 cubic inches. Thus, the oil capacity of cylinder 10 in the exemplary comparison, is 43.48% greater than a traditional cylinder. Again, the nominal cylinder length of approximately 14¼ in., set forth above, is exemplary only. That is to say, it is within the ambit of the present invention to make the cylinder 10 for wider web applications with the dimensional characteristics being appropriately proportioned, although narrow web processes are most preferred.

The larger volume of oil in cylinder 10 resists temperature fluctuations to a greater extent than a lesser volume of oil. Although the cylinder 10 will require more time to reach its rated operating temperature, once that operating temperature is reached, the temperature will be more stable. This leads to a higher average oil temperature as the peak oil temperature remains the same, with temperature drop being minimized. The higher average oil temperature maximizes the temperature gradient, which leads to a reduction in recovery time. Recovery time reduction is proportional to the wall thickness reduction.

When comparing the overall weight of cylinder 10 with a conventional hollowed-out brass hot foil stamping cylinder of the same diameter and length, the traditional cylinder has a typical assembled shipping weight of about 99 lbs., while the cylinder 10 of this invention has a typical assembled shipping weight of about 67 lbs., resulting in a weight reduction of at least about 32% and comparable decrease in freight costs.

Because the tube 12 as fabricated is of uniform thickness throughout, both the external face and the internal surface may be machined as desired to produce a tube 12 having a wall 14 of desired thickness. In most instances, though, only the outer surface of the tube 12 will require machining, in that all sizes of the cylinder 10 preferably will have the same internal diameter. The uniform wall surface makes machining of the internal surface of the tube much easier than internal cantilever machining required with past hot foil stamping cylinders. Furthermore, if a customer orders a 25″ repeat cylinder, and desires a smaller cylinder for another job, e.g., 23″ or 24″ repeat, the 25″ cylinder can be returned and machined to the smaller diameter.

We claim:

1. A thin-walled hot foil stamping cylinder comprising:
a cylindrical tube having a circumferentially-extending wall of predetermined diameter and of initially uniform cross-sectional thickness, said wall presenting a cylindrical interior space, portions of the outer cylindrical surface of the wall having been relieved to define raised, outwardly-projecting hot foil stamping indicia; and
an end cap extending across each of the opposed ends of the tube,
one of the end caps being provided with a passage therethrough for introduction of hot oil into the interior space of the tube.

2. A thin-walled hot foil stamping cylinder as set forth in claim 1, wherein the outer surfaces of the indicia lie in an imaginary cylinder having a diameter correlated with the repeat pattern of the images to be hot foil stamped.

3. A thin-walled hot foil stamping cylinder as set forth in claim 2, wherein the diameter of the tube has been reduced from its initial diameter by removal of material from the outer surface of the tube wall.

4. A thin-walled hot foil stamping cylinder as set forth in claim 1, wherein said tube has an initial wall thickness of from about 0.35 in. to about 0.95 in.

5. A thin-walled hot foil stamping cylinder as set forth in claim 4, wherein said tube has an initial wall thickness of about 0.4 in.

6. A thin-walled hot foil stamping cylinder as set forth in claim 4, wherein said tube has an initial wall thickness of about 0.56 in.

7. A thin-walled hot foil stamping cylinder as set forth in claim 4, wherein said tube has an initial wall thickness of about 0.72 in.

8. A thin-walled hot foil stamping cylinder as set forth in claim 4, wherein said tube has an initial wall thickness of about 0.88 in.

9. A thin-walled hot foil stamping cylinder as set forth in claim 4, wherein said tube is from about 10 in. to about 30 in. in length.

10. A thin-walled hot foil stamping cylinder as set forth in claim 9, wherein said interior space is at least about approximately 400 cu in.

11. A thin-walled hot foil stamping cylinder as set forth in claim 10, wherein said cylinder weighs no more than about 6.47 lbs. per linear inch.

12. A thin-walled hot foil stamping cylinder as set forth in claim 1, wherein said tube is of brass.

13. A thin-walled hot foil stamping cylinder as set forth in claim 1, wherein is provided at least one oil drain passage communicating with the interior space of the tube for draining of oil from the cylinder.

14. A thin-walled hot foil stamping cylinder as set forth in claim 1, wherein one of the end caps has a shaft for connection to a drive gear.

15. A thin-walled hot foil stamping cylinder as set forth in claim 1, wherein is provided a hot oil delivery conduit extending through the passage in said one end cap into the interior space of the tube.

16. A thin-walled hot foil stamping cylinder as set forth in claim 15, wherein the passage in said one end cap is at least about 0.75 in. in diameter.

17. A thin-walled hot foil stamping cylinder as set forth in claim 15, wherein said one end cap has a shaft for connection to a rotary coupling.

18. A method of fabricating a thin-walled hot foil stamping cylinder comprising the steps of:
extruding metal material to form a cylindrical tube having a circumferentially-extending wall of predetermined diameter and of uniform cross-sectional thickness, said wall presenting a cylindrical interior space;
forming a hot foil stamping cylinder of predetermined length and that includes removing portions of the outer cylindrical surface of the wall to present relieved areas defining raised, outwardly-projecting hot foil stamping indicia;
mounting end caps across each of the opposed ends of the tube; and
forming a passage through at least one of the end caps for introduction of hot oil into the interior space of the tube.

19. The method of claim 18, wherein is included the step of limiting the cross-sectional thickness of said wall to a range of from about 0.35 in. to about 0.95 in.

20. The method of claim 18, wherein is included the step of removing said portions of the outer cylindrical surface of the wall by subjecting said outer surface to an etching solution.

21. The method of claim 18, wherein is included the step of machining the outer surface of the tube to remove said portions thereof.

22. The method of claim 18, wherein is included the step of removing material from the outer surface of the tube to decrease the overall diameter thereof.

23. The method of claim 22, wherein material is removed from the overall outer surface of the tube to reduce the tube to a predetermined diameter.
